(19) United States
(12) Patent Application Publication
(10) Pub. No.: US 2007/0246970 A1
(43) Pub. Date: Oct. 25, 2007

(54) Structural acoustic sound baffle for automotive sheet metal cavity applications

(75) Inventors: Carl Widmann, Livonia, MI (US); Michael Donick, Surprise, AZ (US); Bridget Coleman, Dearborn, MI (US)

Correspondence Address: MILLER LAW GROUP, PLLC;AND FORD GLOBAL TECHNOLOGIES, INC., 25 STEVENS AVENUE, WEST LAWN, PA, 19609, US

(73) Assignee: Ford Global Technologies, LLC.

(21) Appl. No.: 11/409,657

(22) Filed: Apr. 24, 2006

(51) Int. Cl. B62D 33/06

(52) U.S. Cl. 296/190.1

(57) ABSTRACT

A structural sound baffle is incorporated into a sheet metal subassembly used in the production of an automotive vehicle, such as a pick-up truck. The structural sound baffle is formed in a Z-shaped configuration that has a first flange welded to the inner panel of the internal cavity, while the second flange is affixed by a heat cured adhesive to the outer panel of the assembly. The baffle joins the two panels to create a more rigid structure than the subassembly without the structural sound baffle affixed thereto. The more rigid structure is less sensitive to boom vibrations, reducing acoustic boom by 64%. In pick-up truck back panel applications, where a retractable window is receivable within the internal cavity of the subassembly, the baffle can be utilized without interfering with the package constraints associated with the retractable back glass configuration.

### FIELD OF THE INVENTION

This invention relates to automotive sheet metal assemblies having an internal cavity between spaced-apart panels and, more particularly, to a structural sound baffle to reduce acoustic boom emanating from the hollow sheet metal assembly.

### BACKGROUND OF THE INVENTION

Automotive vehicles utilize formed sheet metal subassemblies in the production of the vehicle. Such sheet metal subassemblies are formed with longitudinally spaced panels defining an internal cavity therebetween One such sheet metal subassembly is the back panel subassembly forming the back wall of a pick-up truck operator's cab. Under certain circumstances, the natural structural resonances of the sheet metal panels forming the longitudinal limits of the sheet metal subassembly can be excited by vibrational inputs from road variations and from the vehicle's powertrain operation to produce an acoustic boom that is very similar to the beating of a bass drum

Once the sheet metal subassembly is designed, tooling is manufactured and production is started, a re-design of the sheet metal subassembly to change the natural harmonics of the subassembly would require new tooling to be made, and perhaps other adjacent parts to be re-designed to properly interface with a re-designed sheet metal subassembly. Accordingly, post-production changes would present an extremely costly approach to resolving the acoustic boom problem A lower cost solution to this problem is desirable.

In U.S. Pat. No. 5,906,410, granted to Nicholas Dalinkiewicz on May 25, 1999, a load carrying bracket is placed between an inner body panel and the frame of the vehicle. The load carrying bracket is affixed by using a load carrying bolt. U.S. Pat. No. 6,003,274, issued to Joseph Wycech on Dec. 21, 1999, discloses a drop-in insert that is comprised of a pair of U-shaped plates. A layer of foam is applied to the opposite end sections whereupon the expansion of the foam, the cap is intinately bonded to the structural member.

U.S. Pat. No. 6,146,565 issued to Frederick Keller on Nov. 14, 2000, teaches the use of a composite baffle for sealing the cavity of a pillar. The sealing material extends peripherally about the support plate to seal against the internal surfaces of the wall upon heating into an activation temperature. In U.S. Pat. No. 6,341,467, granted to Joseph Wycech on Jan. 29, 2002, a hollow reinforcing beam is provided with an I-beam attached to the principal surfaces of the hollow beam by a layer of thermally expanded foam. The expanded adhesive foam functions to secure the I-beam in place and as a vibration dampening element.

U.S. Pat. No. 6,502,821, granted on Jan. 7, 2003, to Dean Schneider discloses an assembly having an inner panel and an outer panel disposed with a damping member which may be configured to any chosen size, thickness and shape. In U.S. Pat. No. 6,649,243, issued to Steve Roberts, et al on Nov. 18, 2003, discloses a baffle and reinforcing assembly which includes a thermally expansible material which expands and bonds to the surrounding structural member.

The harmonics of the back panel subassembly can be modified by spraying a thick coating of a heavy mastic material on the internal surfaces of the longitudinally spaced sheet metal members. Such a solution to resolving an acoustic booming problem is costly and significantly increases the weight of the back panel subassenbly. Furthermore, the spraying of the heavy mastic material onto the sheet metal members has an inherent variability in the application of the material to the sheet metal members, resulting in a lack of consistency in the effectiveness of the solution to resolve the acoustic booming problem.

Accordingly, it would be desirable to provide a low cost solution to a post-production acoustic boom problem experienced with sheet metal subassemblies defining an internal cavity between a pair of longitudinally spaced panel members, particularly when the hollow subassembly is formed to receive a window within the internal cavity of the sheet metal subassembly.

### SUMMARY OF THE INVENTION

It is an object of this invention to overcome the aforementioned disadvantages of the known prior art by providing a sound baffle that will effectively reduce acoustic booming in wall panels.

It is a feature of this invention that the sound baffle can be utilized in automotive structural wall panels having longitudinally spaced, formed sheet metal panels.

It is an advantage of this invention that the sound baffle changes the harmonics of the structural wall panels.

It is another advantage of this invention that the structural wall panel can be interconnected to reduce susceptibility to acoustic booning by a structural sound baffle.

It is still another feature of this invention that the sound baffle can be utilized in an automotive structural wall panel having a window glass that retracts into the wall panel.

It is another feature of this invention that the sound baffle is welded to one sheet metal member and affixed to the opposing sheet metal member with a layer of adhesive.

It is still another feature of this invention that the sound baffle is formed into a Z-shaped configuration to facilitate the attachment of the sound baffle to the opposing sheet metal members of the back panel subassembly.

It is yet another advantage of this invention that the installed sound baffle increases the rigidity of the back panel subassembly, reducing the sensitivity of the back panel subassembly to boom vibrations.

It is yet another feature of this invention that the sound baffle can be installed into the back panel subassembly without requiring any major revisions to the sheet metal structure while meeting the packaging considerations of a retractable window to be received within the back panel subassembly.

It is still another advantage of this invention that a low cost solution to the acoustic booming problem in back panel subassemblies incorporating a retractable window into the interior cavity of the back panel subassembly.

It is a further advantage of this invention that consistent results with respect to reducing acoustic boom can be obtained through the installation of a structural sound baffle interconnecting the opposing sheet metal members of the back panel subassembly.

It is a further object of this invention to provide a low cost solution to a structural acoustic sound baffle for including a sheet metal subassembly being subjected to an acoustic boom emanating from the panels of the subassembly, in which the solution is inexpensive of manufacture, carefree of maintenance, facile in assemblage, and simple and effective in use.

These and other objects, features and advantages are accomplished according to the instant invention by providing a structural sound baffle for a sheet metal subassembly used in the production of an automotive vehicle. The structural sound baffle is formed in a Z-shaped configuration that has a first flange welded to the inner panel of the internal cavity, while the second flange is affixed by a heat cured adhesive to the outer panel of the assembly. The baffle joins the two panels to create a more rigid structure than the subassembly without the structural sound baffle affixed thereto. The more rigid structure is less sensitive to boom vibrations, reducing acoustic boom by 64%. In pick-up truck back panel applications, where a retractable window is receivable within the internal cavity of the subassembly, the baffle can be utilized without interfering with the package constraints associated with the retractable back glass configuration.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a perspective view of a pick-up truck back panel with a retractable back glass configuration, the retractable back glass being shown in phantom, the structural sound baffle incorporating the principals of the instant invention being shown in dotted lines;

FIG. 2 is a perspective view of the structural sound baffle incorporating the principals of the instant invention; and

FIG. 3 is a representative partial cross-sectional view of the back panel sheet metal subassembly with the structural sound baffle interconnecting the inner and outer panels thereof.

### DETAILED DESCRIPTION OF THE PREFERRED EMBODIMENT

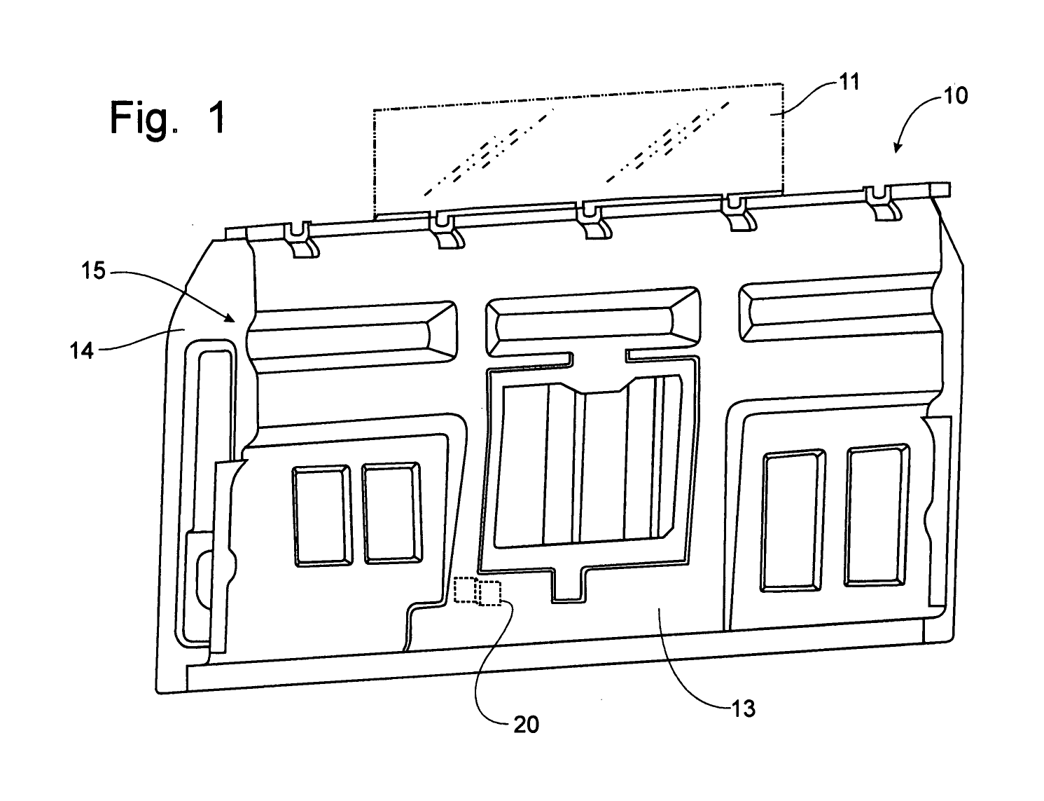

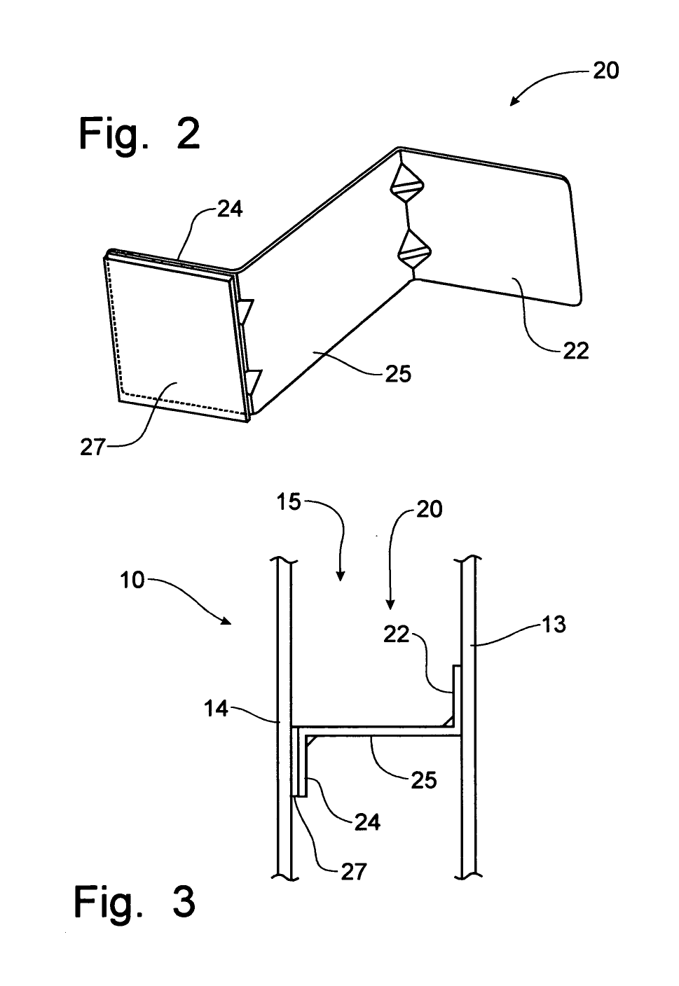

Referring to FIGS. 1-4, a back panel subassembly used in the passenger compartment of an automotive vehicle, such as a pick-up truck, incorporating the principles of the instant invention can best be seen. One skilled in the art will readily recognize that the back panel subassembly 10 is typically used as the rear structural member oriented below the rear window glass of the operator's cab of a pick-up truck, such as is shown in U.S. patent application Ser. No. 10/975,065, of Steve Bruford, et al, now U.S. Pat. No. 6,**,***, the contents of which are incorporated herein by reference. In some pick-up trucks, or sport utility vehicles configured similarly to a pick-up truck, the rear window glass 11 is fixed or is arranged to slide laterally to create selectively a central opening within the rear window glass 11. In some back panel subassemblies 10, such as is shown in FIG. 1, the rear window glass 11 is arranged to retract from a raised position to a lowered position that passes into the internal cavity formed in the back panel subassembly 10. To accommodate the retraction of the rear window glass 11 into the interior cavity 15, the central part of the interior cavity 15 corresponding to the rear window glass 11 must be kept unobstructed.

The back panel subassembly 10 is formed from an inner sheet metal member 13 formed in a generally conventional shape with stiffening depressions formed in the sheet metal member 13, and an outer sheet metal member 14 formed in a configuration to conform to the exterior styling of the vehicle. The inner member 13 and the outer member 14 are formed to be welded or hemmed at the top and bottom portions thereof while defining an interior cavity 15 therebetween. The hollow back panel subassembly 10 must remain unobstructed within the central region thereof corresponding to the retractable rear window glass 11.

A Z-shaped sound baffle 20 is preferably formed with a first mounting flange 22, a second mounting flange 24, and a central strut 25 rigidly interconnecting the two mounting flanges 22, 24. The sound baffle 20 is to be installed with the first mounting flange 22 being welded to the inner sheet metal member 13. The sound baffle 20 will then project outwardly from the inner sheet metal member 13 to be positioned for engagement with the outer sheet metal member 14 being connected to the inner sheet metal member 13. When the inner and outer sheet metal members 13, 14 are connected to each other, such as by welding or by a hemming process, a layer of heat curing adhesive 27, which is preferably applied during the production of the sound baffle 20, is on or applied to the second mounting flange 24 so that the adhesive 27 affixes the second mounting flange 24 to the internal side of the outer sheet metal member 14. The attachment of the second mounting flange 24 to the outer sheet metal member 14 can be accomplished during the paint operation so that the heat applied during the paint operation is also effective to cure the adhesive 27.

After the adhesive has been cured through the application of heat to the assembly, such as the back panel subassembly is subjected to during the coating of the subassembly 10 with paint, the sound baffle 20 rigidly interconnects the inner and outer sheet metal members 13, 14 to substantially increase the rigidity of the subassembly 10 and, thereby, reduce the sensitivity of the subassembly 10 to booming vibrations. As is depicted in FIG. 1, the sound baffle 20 is positioned in a peripheral portion of the interior cavity 15 outside of the central interior cavity envelope required by the retractable rear window glass 11, such as below the retracted window glass 11. A single structural sound baffle 20 may not provide adequate rigidity to the subassembly. Therefore, one or more additional sound baffles 20 may be installed between the inner and outer sheet metal members 13, 14 to further increase the rigidity of the subassembly 10. For example, a second sound baffle 20 can be positioned in a mirrored position on the opposite side of the vertical centerline of the back panel subassembly 10. Similarly, additional sound baffles 20 could positioned in mirrored positions relative to the horizontally extending centerline of the subassembly 10.

Tests have found that a single sound baffle 20 properly located to enhance the rigidity of the back panel subassembly 10 reduced the sensitivity of the back panel subassembly to boom vibrations by approximately 64%. Accordingly, the installation of a structural sound baffle 20 interconnecting the inner and outer sheet metal members 13, 14 of a back panel subassembly 10 presents a practical and effective solution to the acoustic booming problem associated with the back panel subassemblies 10 that are configured to receive a retractable rear window glass 11 within the central portion of the internal cavity 15 of the subassembly 10. Thus interconnected, the sensitivity of the inner and outer sheet metal members 13, 14 is consistently reduced, attaining effectively identical results from one automotive vehicle to another.

The overall design of the back panel subassembly 10 does not need to be changed, with only the accommodations required to position and affixed the sound baffle 20 in the selected position Thus, the production tooling created to form the individual components of the back panel subassembly 10 does not require modification. Accordingly, the installation of the structural sound baffle 20 presents an extremely economical solution to the acoustic boom problem. Such a solution can be implemented into the existing subassembly 10 design with a minimum amount of effort.

One skilled in the art will recognize that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. In a wall panel assembly for an automotive vehicle including an inner panel and an outer panel defining an interior cavity therebetween, the back panel assembly forming a wall of an operator's cab of the automotive vehicle supporting a window glass, the improvement comprising:
a structural sound baffle member positioned within the interior cavity and being affixed to both the inner and outer panel to increase the rigidity of the wall panel assembly.

2. The wall panel assembly of claim 1 wherein the sound baffle is formed with a first mounting flange engagable with the inner panel, a second mounting flange engagable with the outer panel, and a rigid central portion interconnecting the first and second flanges.

3. The wall panel assembly of claim 2 wherein the sound baffle is formed in a Z-shaped configuration with the first mounting flange extending from the central portion in a direction opposite from a direction of orientation of the second flange relative to the central portion.

4. The wall panel assembly of claim 2 wherein the first mounting flange is welded to the inner panel, the second mounting flange being affixed by an adhesive to the outer panel.

5. The wall panel assembly of claim 2 wherein the interior cavity has a central portion and a peripheral portion, the window glass being retractable into the central portion of the interior cavity, the sound baffle being located in the peripheral portion of the interior cavity to prevent interference with the retractable window glass.

6. The wall panel assembly of claim 5 wherein the automotive vehicle is a pick-up truck with the window glass being a rear window of the operator's cab.

7. A back panel assembly forming a rear wall of an operator's cab of a pick-up truck supporting a rear window glass, comprising:
an inner sheet metal panel oriented as an interior side of the operator's cab;
an outer sheet metal panel oriented as an exterior side of the operator's cab; and
a structural sound baffle interconnecting the inner and outer sheet metal panels to increase rigidity of the inner and outer sheet metal panels.

8. The back panel assembly of claim 7 wherein the sound baffle is formed with a first mounting flange engagable with the inner sheet metal panel and a second mounting flange engagable with the outer sheet metal panel.

9. The back panel assembly of claim 8 wherein the first mounting flange is welded to the inner sheet metal panel, the second mounting flange being attached with an adhesive to the outer sheet metal panel.

10. The back panel assembly of claim 9 wherein the first mounting flange extends generally perpendicularly in a first direction from a central web portion of the sound baffle, the second mounting flange extending generally perpendicularly from the central web portion in a second direction opposite of the first direction.

11. The back panel assembly of claim 8 wherein the inner and outer sheet metal panels define an interior cavity therebetween, the interior cavity having a central portion and a peripheral portion, the rear window glass being retractable into the central portion, the sound baffle being located in the peripheral portion of the interior cavity.

12. A back panel assembly for a rear wall of an operator's cab of a pick-up truck supporting a rear window glass, comprising:
a shell having a formed inner sheet metal panel and a formed outer sheet metal panel spaced apart to define an internal cavity therebetween, the internal cavity including a central portion that receives the rear window glass being retracted into the internal cavity and a peripheral portion located around the central portion;
a structural sound baffle interconnecting the inner sheet metal panel and the outer sheet metal panel to increase rigidity in the back panel assembly.

13. The back panel assembly of claim 12 wherein the sound baffle is welded to one of the inner and outer sheet metal panels and attached by adhesives to one of the inner and outer sheet metal panels.

14. The back panel assembly of claim 13 wherein the sound baffle is formed with a central web portion having opposing ends, a first mounting flange extending generally perpendicularly to the central web portion at one end thereof, and a second mounting flange extending generally perpendicularly to the central web portion at the opposing end thereof.

15. The back panel assembly of claim 14 wherein the first and second mounting flanges extend in opposite directions from the central web portion to define a Z-shaped configuration.

16. The back panel assembly of claim 15 wherein the sound baffle is positioned within the peripheral portion of the internal cavity.

17. The back panel assembly of claim 16 wherein first mounting flange is welded to the inner sheet metal panel and the second mounting flange is attached to the second sheet metal panel by adhesives.
